(19) United States
(12) Patent Application Publication
(10) Pub. No.: US 2013/0243218 A1
(43) Pub. Date: Sep. 19, 2013

(54) AUDIO OUTPUT APPARATUS

(71) Applicant: KABUSHIKI KAISHA TOSHIBA, Tokyo (JP)

(72) Inventors: Manabu SAKAI, Kanagawa-ken (JP); Yasuhiro FUKUJU, Kanagawa-ken (JP); Takeshi ISHIZAWA, Kanagawa-ken (JP)

(73) Assignee: KABUSHIKI KAISHA TOSHIBA, Tokyo (JP)

(21) Appl. No.: 13/779,738

(22) Filed: Feb. 27, 2013

(30) Foreign Application Priority Data
Mar. 14, 2012 (JP) 2012-057395

(51) Int. Cl. H04R 3/00

(52) U.S. Cl. CPC H04R 3/00
USPC 381/74; 381/123

(57) ABSTRACT

According to an embodiment, a switch of an audio output device selects any of an output of the buffer and an output of the zero data generation unit to output to the output port. The switch control unit controls the selection of the switch based on an instruction of an output control signal. The front address storage unit stores a setting value of a front address of the buffer. The offset value storage unit stores an offset value set in the buffer. The output address control unit outputs a value obtained by adding the offset value to the setting value of the front address as an output start address of the buffer.

### CROSS REFERENCE TO RELATED APPLICATION

This application is based upon and claims the benefit of priority from the prior Japanese Patent Application No. 2012-057395, filed on Mar. 14, 2012, the entire contents of which are incorporated herein by reference.

### FIELD

Embodiments described herein related to an audio output device.

### BACKGROUND

A system with a plurality of audio output ports such as a multichannel surround system applies different effects to data of each output port in some cases. In this case, time periods required by processing of the respective effects are different, and time periods of PCM (pulse code modulation) data to be outputted to reach output ports respectively, are different. Hence, processing of synthesizing between output ports is required.

Further, when only a specific output port is temporarily stopped and then resumed in a state where output signals are output to a plurality of output ports, it is necessary to synchronize a timing upon resumption and output timings of the other ports.

### BRIEF DESCRIPTION OF THE DRAWINGS

FIG. 1 is a block diagram showing an example of a configuration of an audio output device according to a first embodiment;

FIG. 2 is an explanatory view of a configuration and an address of a buffer unit of the audio output device according to the first embodiment;

FIG. 3 is an explanatory view of an operation of the audio output device according to the first embodiment;

FIG. 4 is a block diagram showing an example of a configuration of an audio output device according to a second embodiment;

FIG. 5 is an explanatory view of an operation of the audio output device according to the second embodiment;

FIG. 6 is a block diagram showing an example of a configuration of an audio output device according to a third embodiment;

FIG. 7 is an explanatory view of an operation of the audio output device according to the third embodiment;

FIG. 8 is a block diagram showing an example of a configuration of an audio output device according to a fourth embodiment; and

FIG. 9 is an explanatory view of an operation of the audio output device according to the fourth embodiment.

### DETAILED DESCRIPTION

According to an embodiment, an audio output device includes an output port, a buffer, a zero data generation unit, a switch, a switch control unit, a front address storage unit, an offset value storage unit, and an output address control unit. The buffer stores data to be outputted to the output port. The zero data generation unit generates zero data. The switch selects any of an output of the buffer and an output of the zero data generation unit to output to the output port. The switch control unit controls the selection of the switch based on an instruction of an output control signal. The front address storage unit stores a setting value of a front address of the buffer. The offset value storage unit stores an offset value set in the buffer. The output address control unit outputs a value obtained by adding the offset value to the setting value of the front address as an output start address of the buffer.

Hereinafter, a plurality of further embodiments will be described with reference to the drawings. In the drawings, the same reference numerals denote the same or similar portions.

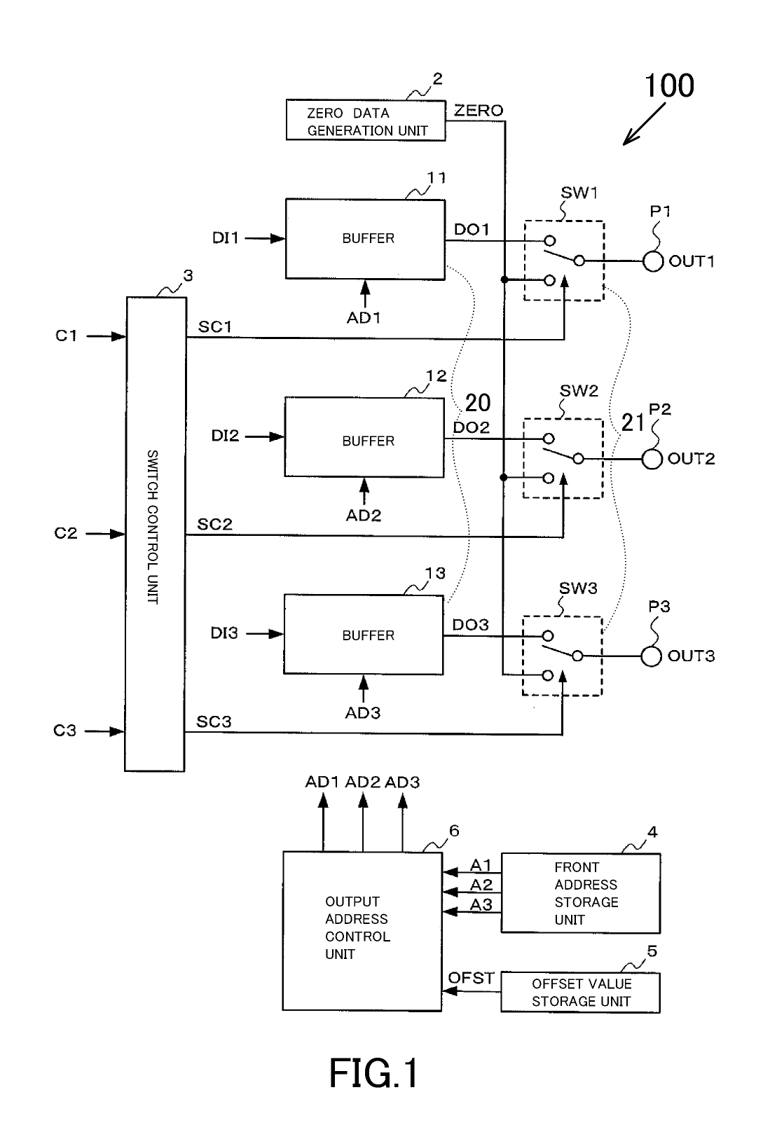

An audio output device according to the first embodiment will be described with reference to the drawings. FIG. 1 is a block diagram showing an example of a configuration of the audio output device. The audio output device according to the embodiment has arbitrary N output ports and, hereinafter, a case will be described as an example where N=3 holds.

As shown in FIG. 1, an audio output device 100 includes a zero data generation unit 2, a switch control unit 3, a front address storage unit 4, an offset value storage unit 5, an output address control unit 6, a buffer unit 20, a switch unit 21, an output port P1, an output port P2 and an output port P3. Audio data is output a speaker and a headphone, for example, through the output port P1, the output port P2 and the output port P3. Although three output ports are provided herein, the number of a output port, a buffer and a switch is preferably determined adequately according to the number of an output destination of audio data.

The buffer unit 20 includes a buffer 11, a buffer 12 and a buffer 13. The buffer 11 stores data DIL The buffer 12 stores data DI2. The buffer 13 stores data DI3. The zero data generation unit 2 outputs zero data. The switch control unit 3 receives an output control signal C1, an output control signal C2 and an output control signal C3, and outputs a selection control signal SC1, a selection control signal SC2 and a selection control signal SC3 for controlling selection of the switch unit 21 based on the output control signals C1 to C3.

The switch unit 21 includes a switch SW1, a switch SW2 and a switch SW3. The switches SW1 to SW3 are DPST (Double-Pole Single-Throw) switches. The switch SW1 selects any of an output DO1 outputted from the buffer 11 and zero data outputted from the zero data generation unit 2 based on the selection control signal SC1 to output to the output port P1. The switch SW2 selects any of an output DO2 outputted from the buffer 12 and zero data outputted from the zero data generation unit 2 based on the selection control signal SC2 to output to the output port P2. The switch SW3 selects any of an output DO3 outputted from the buffer 13 and zero data outputted from the zero data generation unit 2 based on the selection control signal SC3 to output to the output port P3.

The front address storage unit 4 stores a setting value A1 of a front address of the buffer 11, a setting value A2 of a front address of the buffer 12 and a setting value A3 of a front address of the buffer 13. The offset value storage unit 5 stores an offset value OFST commonly set to the buffer 11, the buffer 12 and the buffer 13. The output address control unit 6 outputs an output start address AD1 obtained by adding the offset value OFST to the front address A1, to the buffer 11, outputs an output start address AD2 obtained by adding the offset value OFST to the front address A2, to the buffer 12, and outputs an output start address AD3 obtained by adding the offset value OFST to the front address A3, to the buffer 13.

In the embodiment, FIFO (first-in first out) buffers are used for the buffer 11, the buffer 12 and the buffer 13, for example. The FIFO buffers sequentially store the data DI1, the data DI2 and the data DI3 to be inputted, respectively. The FIFO buffer includes registers. The registers with r bits per stage, respectively, are connected in s stages. Meanwhile, the data DI1, the data DI2 and the data DI3 are PCM (pulse code modulation) data obtained by performing digital processing of an audio as analog data. The PCM data is data sampled (quantified) per a certain period of time. The buffer 11, the buffer 12 and the buffer 13 are also referred to as “PCM buffers”.

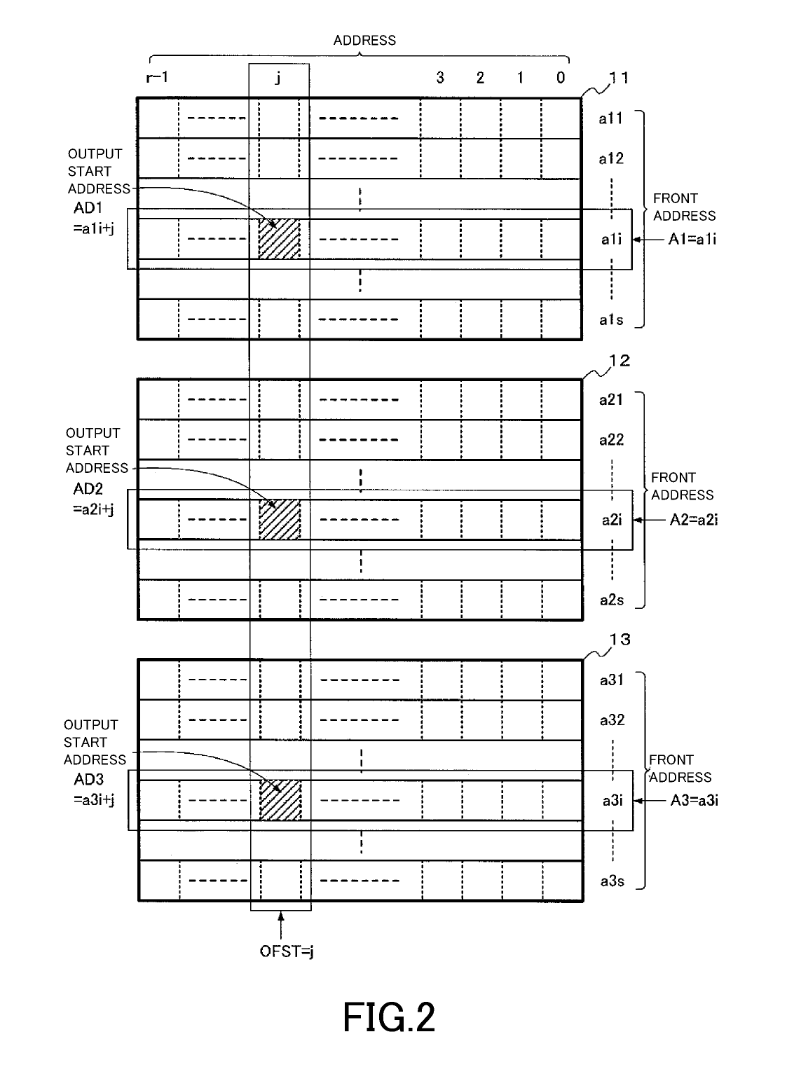

FIG. 2 is an explanatory view of a configuration and an address of the buffer unit, and shows relationships between configurations and addresses of the buffer 11, the buffer 12 and the buffer 13 when the FIFO buffers are used.

Hereinafter, addresses of registers at each stage of the buffer 11, the buffer 12 and the buffer 13 are represented as 0 to (r−1), and front addresses at each stage are represented as a11 to a1s in the buffer 11, a21 to a2s in the buffer 12, and a31 to a3s in the buffer 13.

The front address storage unit 4 stores the front address A1, the front address A2 and the front address A3 set from an outside with respect to the buffer 11, the buffer 12 and the buffer 13, respectively employing the configurations shown in FIG. 2.

Further, the offset value storage unit 5 stores an offset value OFST as an address of a register. The offset value OFST is commonly set to the buffer 11, the buffer 12 and the buffer 13.

The output address control unit 6 uses a value obtained by adding the offset value OFST read from the offset value storage unit 5, to the front address A1 read from the front address storage unit 4 as the output start address AD1 of the buffer 11. The output address control unit 6 uses a value obtained by adding the offset value OFST read from the offset value storage unit 5, to the front address A2 read from the front address storage unit 4 as the output start address AD2 of the buffer 12. The output address control unit 6 uses a value obtained by adding the offset value OFST read from the offset value storage unit 5, to the front address A3 read from the front address storage unit 4 as the output start address AD3 of the buffer 13.

When A1=a1i, A2=a2i and A3=a3i are set as the front address A1, the front address A2 and the front address A3 and OFST=j is set as the offset value OFST, for example, as shown in FIG. 2, the output address control unit 6 outputs AD1=a1i+j, AD2=a2i+j and AD3=a3i+j as the output start address AD1, the output start address AD2 and the output start address AD3.

Data stored in the buffer 11 is read out the output start address AD1 as the front. Data stored in the buffer 12 is read out the output start address AD2 as the front. Data stored in the buffer 13 is read out the output start address AD3 as the front.

The switch control unit 3 outputs the selection control signal SC1 to the switch SW1 based on an instruction of the output control signal C1. The switch control unit 3 outputs the selection control signal SC2 to the switch SW2 based on an instruction of the output control signal C2. The switch control unit 3 outputs the selection control signal SC3 to the switch SW3 based on an instruction of the output control signal C3.

The switch control unit 3 controls the switch SW1 to output the output DO1 of the buffer 11 to the output port P1 when the output control signal C1 is at a “high level”. The switch control unit 3 controls the switch SW2 to output the output DO2 of the buffer 12 to the output port P2 when the output control signal C2 is at the “high level”. The switch control unit 3 controls the switch SW3 to output the output DO3 of the buffer 13 to the output port P3 when the output control signal C3 is at the “high level”.

The switch control unit 3 controls the switch SW1 to output zero data outputted from the zero data generation unit 2 to the output port P1 when the output control signal C1 is at a “low level”. The switch control unit 3 controls the switch SW2 to output zero data outputted from the zero data generation unit 2 to the output port P2 when the output control signal C2 is at the “low level”. The switch control unit 3 controls the switch SW3 to output zero data outputted from the zero data generation unit 2 to the output port P3 when the output control signal C3 is at the “low level”.

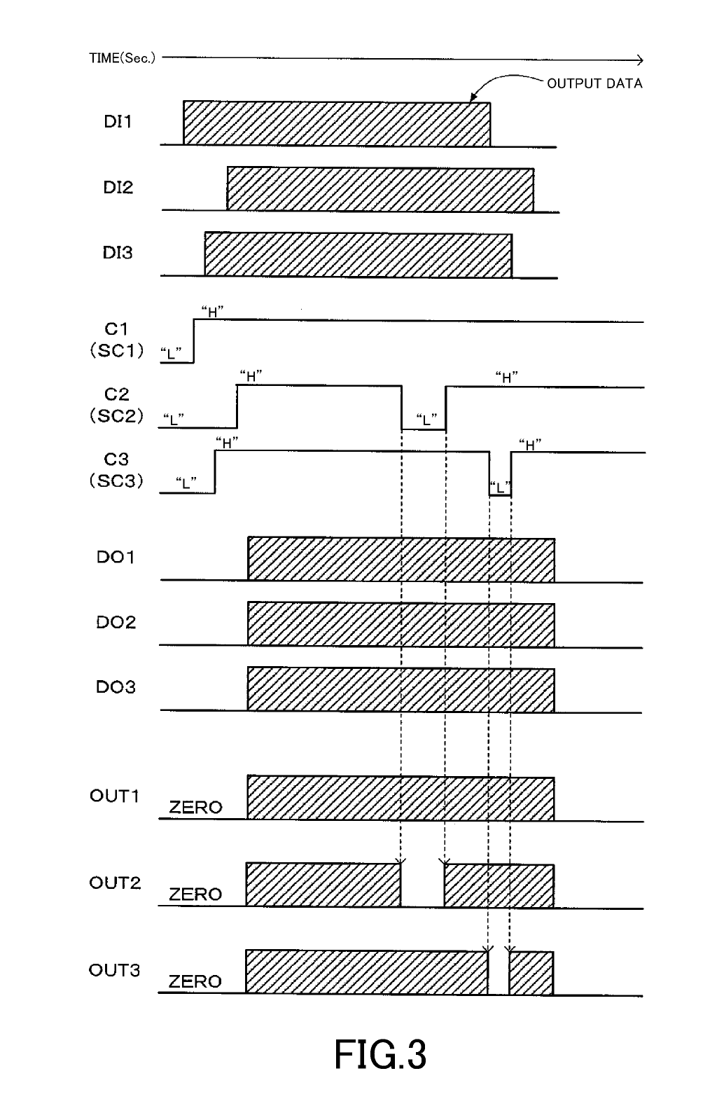

FIG. 3 is an explanatory view of an operation of the audio output device, and shows an example of the operation of the audio output device according to the embodiment on a time axis.

As shown in FIG. 3, the output control signal C1, the output control signal C2 and the output control signal C3 are set to the “low level” in the initial state. Output data OUT1 outputted from the output port P1, output data OUT2 outputted from the output port P2 and output data OUT3 outputted from the output port P3 are zero data.

Next, an input of data to the buffer 11, the buffer 12 and the buffer 13 is started. The data DI1 inputted to the buffer 11, the data DI2 inputted to the buffer 12 and the data DI3 inputted to the buffer 13 are PCM data obtained by applying different acoustic processings to the original audio data. Time periods required for the acoustic processing are different, respectively, and therefore there are shifts in input timings of the data DI1, the data DI2 and the data DI3. As a result, a timing when the data DI1 is stored in the buffer 11, a timing when the data DI2 is stored in the buffer 12 and a timing when the data DI3 is stored in the buffer 13 are different, respectively.

Hence, in the embodiment, the output control signal C1, the output control signal C2 and the output control signal C3 are, respectively, switched from the “low levels” to the “high levels”, taking into account timings to store data in the buffer 11, the buffer 12 and the buffer 13, respectively.

In the embodiment, the switch control unit 3 outputs signals using timings to select the output control signal C1, the output control signal C2 and the output control signal C3 as timings to select the selection control signal SC1, the selection control signal SC2 and the selection control signal SC3 without change.

The output address control unit 6 outputs the output start address AD1, the output start address AD2 and the output start address AD3.

Meanwhile, the output start address AD1 is a value obtained by adding the common offset value OFST to the front address A1 of the buffer 11. The output start address AD2 is a value obtained by adding the common offset value OFST to the front address A2 of the buffer 12. The output start address AD3 is a value obtained by adding the common offset value OFST to the front address A3 of the buffer 13.

That is, in the embodiment, the offset value OFST is commonly set to the buffer 11, the buffer 12 and the buffer 13. Hence, an output timing of the data DO1 outputted from the buffer 11, an output timing of the data DO2 outputted from the buffer 12 and an output timing of the data DO3 outputted from the buffer 13 are set as the same timing.

The output data DO1 outputted from the buffer 11 is the output data OUT1 outputted from the output port P1. The output data DO2 outputted from the buffer 12 is the output data OUT2 outputted from the output port P2. The output data DO3 outputted from the buffer 13 is the output data OUT3 outputted from the output port P3.

As described above, in the audio output device 100 according to the embodiment, it is able to output data to which different acoustic processings are applied, at the same timings from all output ports.

Further, in the audio output device 100 according to the embodiment, it is able to dynamically stop an output and dynamically resume an output from a specific port by controlling the output control signal C1, the output control signal C2 and the output control signal C3.

When the output is dynamically stopped, an output control signal of a port from which an output needs to be stopped sets the “low level”, and the port has the output with zero data.

FIG. 3 shows an example where outputs are dynamically stopped from the output port P2 and the output port P3. While outputs are dynamically stopped, the output control signal C2 and the output control signal C3 are temporarily set to the “low level”, and the output port P2 and the output port P3 have the output with zero data.

Next, when an output from the port is dynamically resumed, the output control signal of the port is set to the “high level” again, and the output of the port is set to an output from the buffer unit again. Consequently, the output timing of the output and the output timings of the other ports are synchronized.

As described above, in the audio output device according to the embodiment, it is able to align the output start address AD1 of the buffer 11, the output start address AD2 of the buffer 12 and the output start address AD3 of the buffer 13 to the same position by setting the common offset value OFST, so that, even when input timings of ports are different, it is possible to output data at the same timing from all ports.

Further, it is possible to dynamically stop and resume an output per port and synchronize output timings of the port to the other ports even when the output is resumed after the output is dynamically stopped.

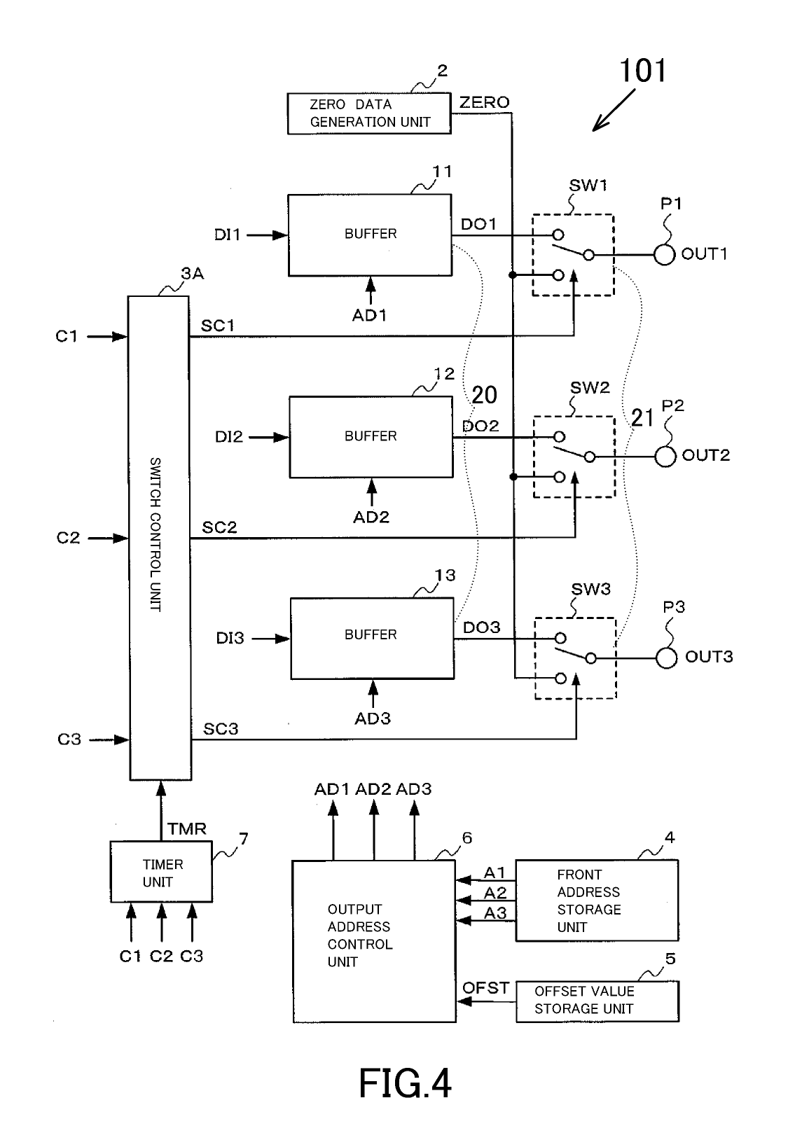

A second embodiment will be described with reference to the drawings. FIG. 4 is a block diagram showing an example of a configuration of an audio output device.

Hence, in the first embodiment, an output control signal C1, an output control signal C2 and an output control signal C3 are switched from “low level” to “high level”, respectively, taking into account timings to store data in a buffer 11, a buffer 12 and a buffer 13, respectively. Accordingly, adjusting timings of the output control signal C1, the output control signal C2 and the output control signal C3 becomes complicated. Hence, a case will be described as an example with the embodiment where the audio output device does not need to adjust individual timings of the output control signal C1, the output control signal C2 and the output control signal C3.

As shown in FIG. 4, in an audio output device 101, a timer unit 7 is added to the audio output device 100 according to the first embodiment and a switch control unit 3 is changed to a switch control unit 3A. The other configurations are the same as those of the first embodiment, and therefore only differences will be described.

The timer unit 7 includes a counter which starts counting when any of the output control signal C1, the output control signal C2 and the output control signal C3 indicates the “high level”, and counts a predetermined time T.

The predetermined time T is set to a value based on an estimation of a maximum delay time of a timing to store input data DI1 in the buffer 11, a timing to store input data DI2 in the buffer 12 and a timing to store input data DI3 in the buffer 13.

The switch control unit 3A executes selection of a switch SW1, a switch SW2 and a switch SW3 according to the output control signal C1, the output control signal C2 and the output control signal C3, respectively at a point of time when the timer unit 7 finishes counting the predetermined time T.

That is, the switch control unit 3A sets a selection control signal SC1 to the “high level” for a signal indicating that the output control signal C1 is the “high level” at a point of time when the timer unit 7 finishes counting the predetermined time T. The switch control unit 3A sets a selection control signal SC2 to the “high level” for a signal indicating that the output control signal C2 is the “high level”. The switch control unit 3A sets a selection control signal SC3 to the “high level” for a signal indicating that the output control signal C3 is the “high level”.

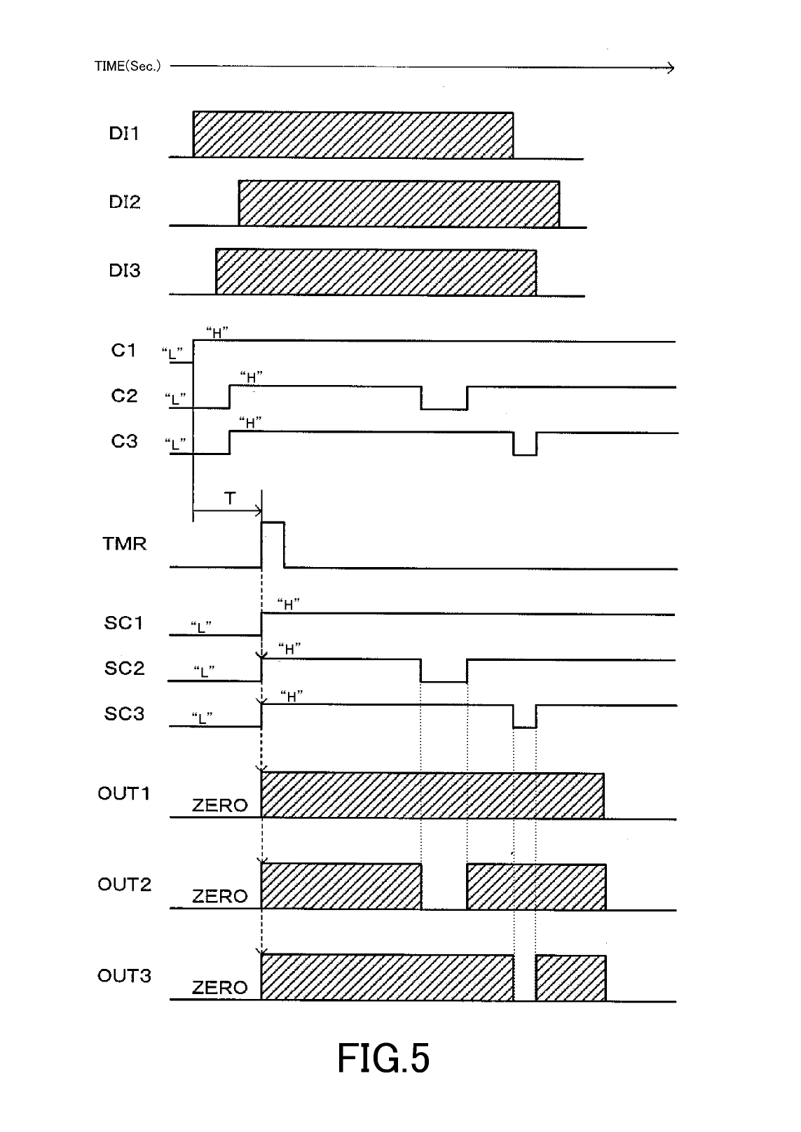

FIG. 5 is an explanatory view of an operation of the audio output device, and shows an example of the operation of the audio output device according to the embodiment on a time axis.

As shown in FIG. 5, when data is inputted to the buffer 11, the buffer 12 and the buffer 13, the output control signal C1 first changes from the “low level” to the “high level”. In response to the change, the timer unit 7 starts counting. When the predetermined time T passes, an output TMR of the timer unit 7 changes.

The output control signal C2 and the output control signal C3 have the “high levels” after the predetermined time T passes, and then the switch control unit 3A changes all of the switch SW1, the switch SW2 and the switch SW3 to the “high level”.

As a result, outputs of the switch SW1, the switch SW2 and the switch SW3 are changed. Output data DO1 outputted from the buffer 11 is output data OUT1 outputted to an output port P1. Output data DO2 outputted from the buffer 12 is output data OUT2 outputted to an output port P2. Output data DO3 outputted from the buffer 13 is output data OUT3 outputted to an output port P3.

In this case, the output data DO1 from the buffer 11, the output data DO2 from the buffer 12 and the output data DO3 from the buffer 13 are data of the same timing in which positions of output start addresses are aligned similar to the first embodiment.

As described above, in the audio output device according to the embodiment, it is able to output data to all ports at the same timing without individually synchronizing timings to switch the output control signal C1, the output control signal C2 and the output control signal C3 from the “low level” to the “high level” by setting the predetermined time T to the timer unit 7. Consequently, it is possible to prevent adjustment of timings of the output control signal C1, the output control signal C2 and the output control signal C3 from being complicated.

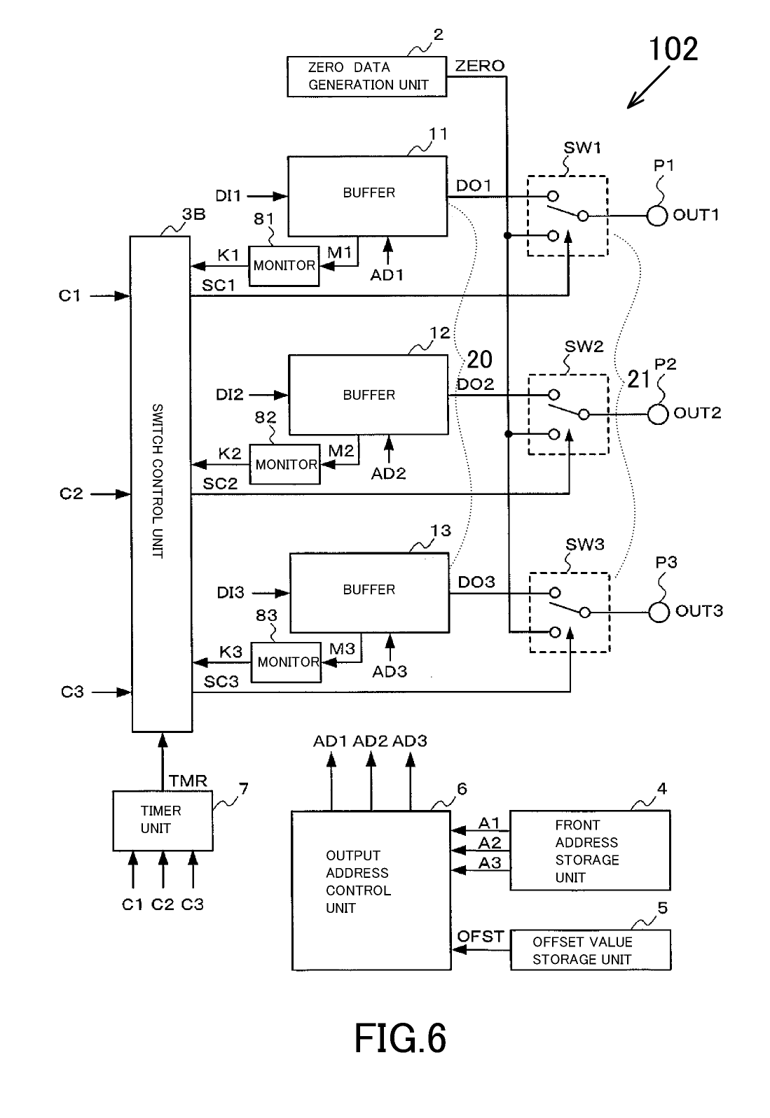

A third embodiment will be described with reference to the drawings. FIG. 6 is a block diagram showing an example of a configuration of an audio output device.

In the first embodiment and the second embodiment, when an output control signal switches to a “high level”, the output data is outputted to the output port, even the data does not store in the buffer unit. In this case, there is a risk that output data of the output port includes abnormal data such as noise. Hence, an example of the audio output device will be described with the embodiment where, even when an output control signal changes to the “high level”, when data is not stored, an output of the buffer unit is not outputted to the output port.

As shown in FIG. 6, in an audio output device 102, a monitor 81, a monitor 82 and a monitor 83 are added to an audio output device 101 according to the second embodiment, and a switch control unit 3A is changed to a switch control unit 3B. The other configurations are the same as in the second embodiment, and therefore only differences will be described.

In addition, the above change may be applied to an audio output device 100 according to the first embodiment instead of the second embodiment.

The monitor 81 monitors a data storage status M1 of a buffer 11, and outputs a data storage monitoring signal K1 indicating “storage”/“non-storage” of data to the switch control unit 3B. The monitor 82 monitors a data storage status M2 of a buffer 12, and outputs a data storage monitoring signal K2 indicating “storage”/“non-storage” of data to the switch control unit 3B. The monitor 83 monitors a data storage status M3 of a buffer 13, and outputs a data storage monitoring signal K3 indicating “storage”/“non-storage” of data to the switch control unit 3B.

While the data storage monitoring signal K1 outputted from the monitor 81 indicates “non-storage” of data, even when the output control signal C1 indicates the “high level”, the switch control unit 3B does not change a selection control signal SC1 to the “high level”. While the data storage monitoring signal K2 outputted from the monitor 82 indicates “non-storage” of data, even when the output control signal C2 indicates the “high level”, the switch control unit 3B does not change a selection control signal SC2 to the “high level”. While the data storage monitoring signal K3 outputted from the monitor 83 indicates “non-storage” of data, even when the output control signal C3 indicates the “high level”, the switch control unit 3B does not change a selection control signal SC3 to the “high level”.

As a result, a switch SW1 does not execute data selection from the buffer 11, a switch SW2 does not execute data selection from the buffer 12 and the switch SW3 does not execute data selection from the buffer 13.

Further, similar to the second embodiment, in the embodiment, until a timer unit 7 finishes counting a predetermined time T, the selection control signal SC1, the selection control signal SC2 and the selection control signal SC3 are not changed to the “high level”.

That is, in the embodiment, the selection control signal SC1, the selection control signal SC2 and the selection control signal SC3 are changed to the “high level” at a point of time when the timer unit 7 finishes counting the predetermined time T, that is, only when the output control signal C1, the output control signal C2 and the output control signal C3 indicate the “high level” and the data storage monitoring signal K1, the data storage monitoring signal K2 and the data storage monitoring signal K3 indicate “storage”.

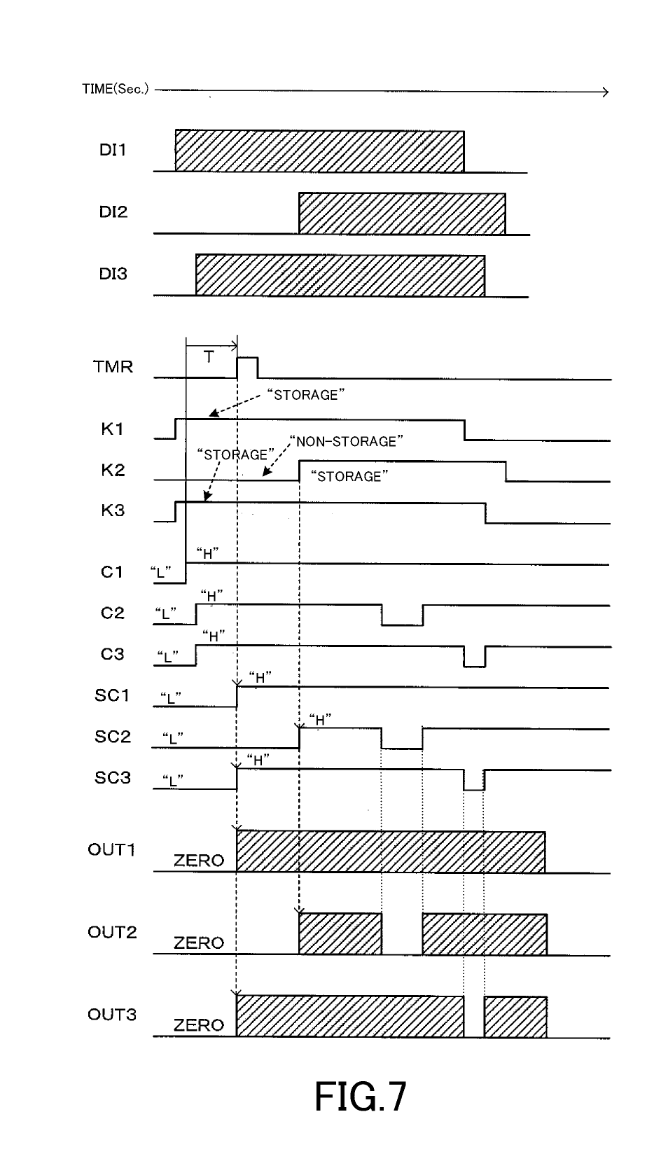

FIG. 7 is an explanatory view of an operation of the audio output device, and shows an example of the operation of the audio output device on a time axis.

In an example of FIG. 7, the output control signal C1 first changes to the “high level”, and the output control signal C2 and the output control signal C3 change to the “high level”.

When the output control signal C1 changes to the “high level”, the timer unit 7 starts counting, and an output signal TMR indicates that the predetermined time T passes.

After the predetermined time T passes, the data storage monitoring signal K1 and the data storage monitoring signal K3 indicate “storage”. As a result, the selection control signal SC1 and the selection control signal SC3 change to the “high level”. The output data of the buffer 11 is outputted to an output port P1 and becomes output data OUT1. Output data of the buffer 13 is outputted to an output port P3, and becomes output data OUT3.

On the other hand, the data storage monitoring signal K2 indicates “non-storage” at a point of time when the output signal TMR indicates that the predetermined time T passes. Therefore, a selection control signal SC2 does not change to the “high level”, and maintains the “low level” at the point of time.

Hence, zero data is continuously outputted to an output port P2.

Subsequently, when the data storage monitoring signal K2 indicates “storage”, the selection control signal SC2 changes to the “high level” at the point of time. As a result, output data of the buffer 12 is outputted to the output port P2, and becomes output data OUT2.

As described above, the audio output device according to the embodiment can monitor data storage statuses of the buffer 11, the buffer 12 and the buffer 13, and, when there is a buffer unit which does not store data, prevent an output of the buffer unit from being outputted to the output port even when an output control signal changes to the “high level”. Consequently, it is possible to prevent abnormal data such as noise from being outputted to the output port.

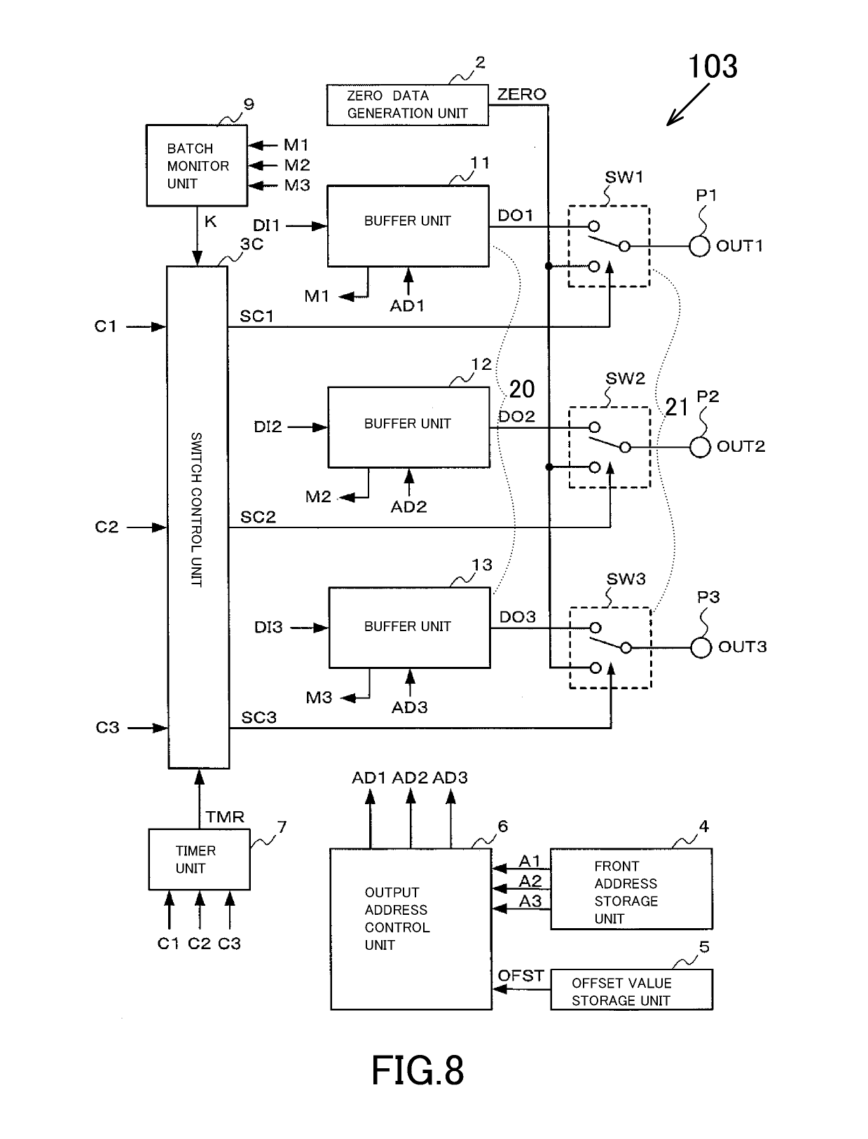

A fourth embodiment will be described below with reference to the drawings. FIG. 8 is a block diagram showing an example of a configuration of an audio output device according to the fourth embodiment.

In the third embodiment, responsivity is weighed heavily, that is, as soon as data is stored in a buffer unit, an output to an output port is executed. However, outputs to output ports are simultaneously started at a point of time when data is stored in all buffer units depending on usage, for example, that is, synchronicity is weighed heavily. Hence, a case will be described with the embodiment where the audio output device is able to simultaneously start outputting outputs to output ports at a point of time when data is stored in all buffer units.

As shown in FIG. 8, in an audio output device 103, a batch monitor unit 9 is provided instead of a monitor 81, a monitor 82 and a monitor 83 of an audio output device 102 according to the third embodiment, and a switch control unit 3B is changed to a switch control unit 3C. The other configurations are the same as those of the third embodiment, and therefore only differences will be described.

In the third embodiment, the monitor 81 monitors a data storage status M1 of a buffer 11, the monitor 82 monitors a data storage status M2 of a buffer 12 and the monitor 83 monitors a data storage status M3 of a buffer 13. In the embodiment, the batch monitor unit 9 collectively monitors the data storage status M1 of the buffer 11, the data storage status M2 of the buffer 12 and the data storage status M3 of the buffer 13.

The batch monitor unit 9 monitors the data storage status M1 of the buffer 11, the data storage status M2 of the buffer 12 and the data storage status M3 of the buffer 13, and outputs a data storage monitoring signal K indicating the data storage status, to a switch control unit 3C. The batch monitor unit 9 has the storage monitoring signal K indicating “storage” when data is stored in all buffer units, and has the storage monitoring signal K indicating “non-storage” when data is not stored in one of the buffer units.

While the data storage monitoring signal K outputted from the batch monitor unit 9 indicates “non-storage”, even when an output control signal C1, an output control signal C2 and an output control signal C3 indicate the “high levels” at a point of time when a timer unit 7 finishes counting a predetermined time T, the switch control unit 3C does not change a selection control signal SC1, a selection control signal SC2 and a selection control signal SC3 to the “high levels”.

As a result, a switch SW1 does not execute data selection from the buffer 11, a switch SW2 does not execute data selection from the buffer 12 and a switch SW3 does not execute data selection from the buffer 13.

The selection control signal SC1, the selection control signal SC2 and the selection control signal SC3 are changed to the “high level” at a point of time when the timer unit 7 finishes counting the predetermined time T, that is, only when the output control signal C1, the output control signal C2 and the output control signal C3 indicate the “high level” and the data storage monitoring signal K indicates “storage”.

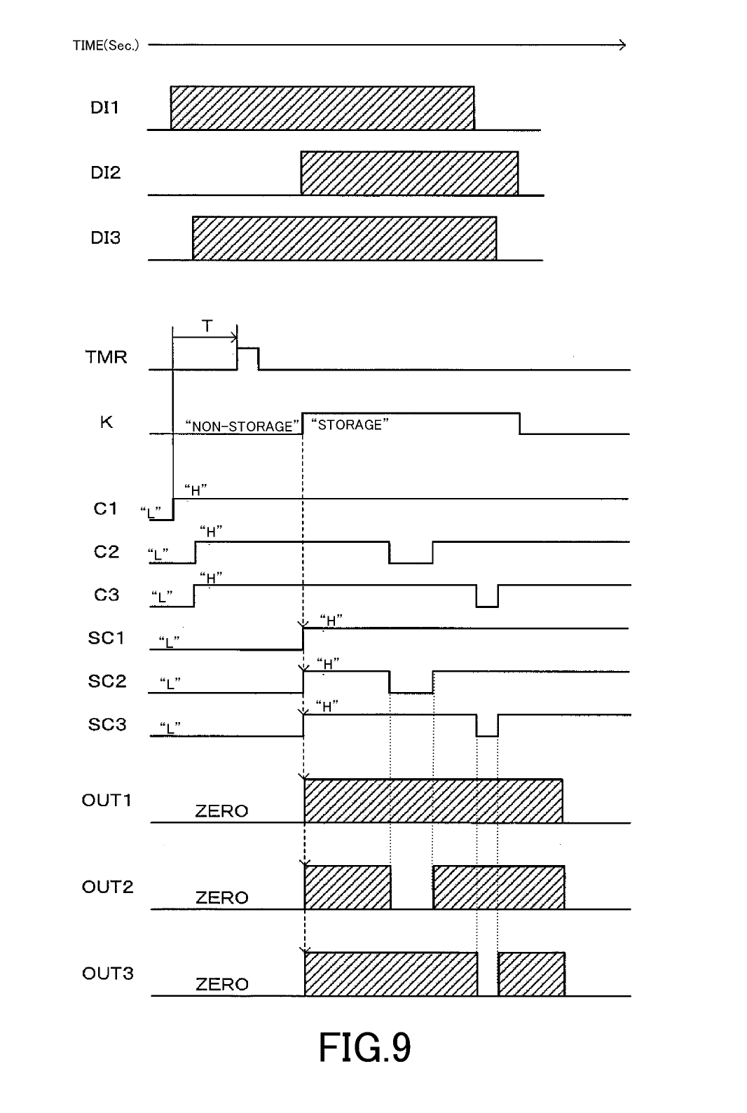

FIG. 9 is an explanatory view of an operation of the audio output device, and shows an example of the operation of the audio output device on a time axis.

In an example of FIG. 9, the output control signal C1 first changes to the “high level”, and the output control signal C2 and the output control signal C3 change to the “high level”.

When the output control signal C1 changes to the “high level”, the timer unit 7 starts counting, and an output signal TMR indicates that the predetermined time T passes.

After the predetermined time T passes, while data is stored in the buffer 11 and the buffer 13, data is not stored in the buffer 12. As a result, the data storage monitoring signal K outputted from the batch monitor unit 9 indicates “non-storage”. Hence, the selection control signal SC1, the selection control signal SC2 and the selection control signal SC3 maintain the “low level”.

Next, when data is stored in the buffer 12, a data storage monitoring signal K2 changes to “storage”. In this case, the selection control signal SC1, the selection control signal SC2 and the selection control signal SC3 simultaneously change to the “high level”. Simultaneously, output data of the buffer 11 is outputted to an output port P1, output data of the buffer 12 is outputted to an output port P2 and output data of the buffer 13 is outputted to an output port P3. As a result, the output data of the buffer 11 becomes output data OUT1, the output data of the buffer 12 becomes output data OUT2 and the output data of the buffer 13 becomes output data OUT3, simultaneously.

As described above, the audio output device according to the embodiment collectively monitors data storage statuses of the buffer 11, the buffer 12 and the buffer 13. The switch SW1, the switch SW2 and the switch SW3 is able to execute data selection to output outputs of all buffer units to output ports at a point of time when data is stored in all buffer units. Consequently, it is possible to simultaneously start outputting the output data of the buffer 11 to the output port P1, outputting the output data of the buffer 12 to the output port P2 and outputting the output data of the buffer 13 to the output port P3.

The above-described audio output device according to at least one of embodiments is able to easily synchronize output timings between a plurality of output ports.

While certain embodiments have been described, these embodiments have been presented by way of example only, and are not intend to limit the scope of the inventions. Indeed, the novel embodiments described herein may be embodied in a variety of the other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An audio output device, comprising:
an output port;
a buffer to store data to be outputted to the output port;
a zero data generation unit to generate zero data;
a switch to select any of an output of the buffer and an output of the zero data generation unit to output to the output port;
a switch control unit to control the selection of the switch based on an instruction of an output control signal;
a front address storage unit to store a setting value of a front address of the buffer;
an offset value storage unit to store an offset value set in the buffer; and
an output address control unit to output a value obtained by adding the offset value to the setting value of the front address as an output start address of the buffer.

2. The audio output device according to claim 1, wherein
N output ports, N buffers and N switches (where N is an integer equal to or more than two) are provided,
the offset value is commonly set to the N buffers,
the audio output device, further comprising:
a timer unit to start counting when the output control signal indicates that any of the N buffers starts outputting an output, and count a predetermined time, and wherein
the switch control unit executes the selection of the switch based on the output control signal at a point of time when the timer unit finishes the counting.

3. The audio output device according to claim 2, further comprising:
N monitors to individually monitor data storage conditions of the N buffers,
wherein, while the monitors detect that data is not stored, the switch control unit does not instruct the switch to select an output from the buffer even in a state in which the output control signal indicates that the output from the buffer is selected.

4. The audio output device according to claim 1, wherein
N output ports, N buffers and N switches (where N is an integer equal to or more than two) are provided, and
the offset value is commonly set to the N buffers,
the audio output device, further comprising:
a timer unit to start counting when the output control signal indicates that any of the N buffers starts outputting an output, and count a predetermined time; and
a batch monitor unit to collectively monitor data storage conditions of the N buffers.

5. The audio output device according to claim 4, wherein, while the batch monitor unit detects that data is not stored in any of the N buffers, the switch does not execute selection of an output from the buffer even in a state in which the output control signal indicates that the output from the buffer is selected after the timer unit finishes the counting.

6. The audio output device according to claim 1, wherein the buffer is a FIFO buffer.

7. The audio output device according to claim 1, wherein data stored in the buffer is audio data subjected to acoustic processing.

8. The audio output device according to claim 7, wherein the audio data is PCM data.

9. The audio output device according to claim 7, wherein the audio data is outputted to at least one of a speaker and a head phone.

10. The audio output device according to claim 1, wherein the switch is a DPST switch.
